(19) United States
(12) Patent Application Publication
(10) Pub. No.: US 2002/0121815 A1
(43) Pub. Date: Sep. 5, 2002

(54) Magnetically powered reciprocating engine

(76) Inventor: Mark L. Sullivan, Johnstown, PA (US)

Correspondence Address: H. Keith Hauger, Esquire, 10526 Old Trail Rd., N. Huntingon, PA, 15642, US

(21) Appl. No.: 09/798,213

(22) Filed: Mar. 5, 2001

(51) Int. Cl. H02K 35/00

(52) U.S. Cl. 310/33

(57) ABSTRACT

A magnetically powered engine adaptable to and modifiable to any gasoline-powered automobile, truck, motorcycle, bus, marine and other small engines having an engine block containing at least one cylinder, at least one piston, a crankcase, and at least one connecting rod secured to a lower portion of said piston and pivotally to a crankshaft enclosed in said crankcase. An electrical power source provides electrical current to an electromagnet fastened within a head of a cylinder, whereby said electromagnet is opposed to a permanent magnet having a fixed charge and secured to an upper surface of a piston for creating a magnetic field between the electromagnet and the permanent magnet causing a magnetic force driving the piston away from the electromagnet and reciprocating to cause a repulsive magnetic force between an adjacent electromagnet and permanent magnet, thus, transferring this reciprocating motion to a crankshaft and ultimately to a driveshaft in any powered vehicle, including automobiles, trucks, motorcycles, buses, and small engines, and likewise, adaptable to marine engines for driving a shaft which turns a propellor apparatus. The magnetically powered engine is also adaptable to smaller engines, including lawn mowers, small tractors, weedeaters and other similar gasoline-powered motors. Adaptation to the magnetically powered engine eliminates many components of a typical gasoline-powered engine including gasoline tanks, fuel lines, fuel pumps, tail pipes, mufflers, carburetors, etc.

### BACKGROUND OF THE INVENTION

1. Field of the Invention

This invention relates generally to a magnetically powered reciprocating engine especially adaptable to and modifiable to any gasoline powered automobile, truck, marine or other small engines.

2. Description of the Prior Art

The gasoline powered engine has been a major factor in American industry and manufacturing, as well as abroad. Technologies have produced hybrid electric and fuel cell vehicles which offer the prospect of significant emissions reductions for both toxic pollutants and greenhouse gases. Government policies and incentives now encourage an alternative to the gasoline engine. Thus, the government has a deep interest in both the cost and environmental benefits of an alternatively fueled engine due to the fact that road transport is one of the major sources of air pollution, especially in urban areas.

One attempt at a self-timing piston electric engine is disclosed in U.S. Pat. No. 2,296,554 issued to A. K. Hinchman. Hinchman's invention relates to a self-timing piston electric engine setting forth a cylinder which includes primary and secondary electro-magnetic coils acting upon the piston to cause it to reciprocate. The coils are energized at proper periods by relay timers controlled or actuated by the movements of the piston.

U.S. Pat. No. 3,939,367 issued to Ramirez discloses a permanent magnet and electro-magnet actuated mechanical unit that may be secured to an engine block assembly to actuate at least one piston, connecting rod and driveshaft that forms a part of the assembly to obtain rotary power.

U.S. Pat. No. 4,179,631 issued to Funderburg discloses a pair of spaced, toroidal-shaped, electromagnetic coils which are enclosed in a cylindrical housing and when supplied with alternative D.C. current, cause a floating armature to reciprocate there between.

Demand in the engine and motor industry of today is for a higher quality and cleaner running units. The invention presented in this application meets the criteria of modern society and industry.

### SUMMARY OF THE INVENTION

It is, therefore, an object of the present invention to provide a magnetically powered engine adaptable to and modifiable to any gasoline-powered automobile, truck, marine and other small engines representing a substantial improvement over the prior art in its capability of power production without expulsion of toxic fumes to the environment.

It is a further object of the present invention to provide a means of converting any gas motor to operate by use of permanent and electromagnets with minimal machining and resulting in a relatively inexpensive process of conversion.

It is a further object of the present invention to ultimately provide a lighter vehicle, after the adaptation, due to the fact that many of the parts of a gasoline engine, and in particular, an automobile engine and/or automobile, will no longer be necessary, and thus, lowering the overall weight.

It is a further object of the present invention to eliminate gasoline tanks, fuel lines, fuel pumps, tail pipes, mufflers, catalytic converters, radiators, hoses, antifreeze coolant, carburetor injections and other components which will no longer be necessary.

It is a further object of the present invention to provide a magnetically powered engine adaptable to marine engines for driving a shaft which turns a propellor apparatus.

It is a further object of the present invention to provide a magnetically-powered engine that runs quietly and is pollution free.

It is a further object of the present invention to provide a magnetically-powered engine that is easily adaptable to any gasoline engine in an automobile, truck, bus, motorcycle, lawn mower, tractor, motor boat, weed eaters, and any other gasoline powered motor.

More specifically, the present invention is a magnetically powered engine adaptable to and modifiable to any gasoline-powered automobile, truck, marine and other small engines comprising, in combination an engine block having at least one cylinder, at least one piston, a crankcase, at least one connecting rod secured to a lower portion of said piston and pivotally to a crankshaft enclosed in said crankcase; an electrical power source providing electrical current to an electromagnet fastened within a head of said cylinder; a permanent magnet secured to an upper surface of said piston for creation of a repulsive magnetic field between said electromagnet and said permanent magnet, causing said permanent magnet to drive said piston away from said electromagnet in said head, driving said piston in an upward motion and then in a downward motion within said cylinder, and thereby, transferring said upward motion and said downward motion to said crankshaft by means of said connecting rod.

These objects, as well as the other objects and advantages of the present invention will become apparent from the following description in reference to the illustrations appended hereto.

### BRIEF DESCRIPTION OF THE DRAWINGS

For a better understanding of the invention, reference may be had to the accompanying drawings in which:

FIG. 1 is a side cross-sectional view of a magnetically powered reciprocating engine showing a repulsive electromagnetic field creating a downward piston motion.

FIG. 2 is a side cross-sectional view of a magnetically powered reciprocating engine showing an upward piston motion when the electromagnet is in an off position.

FIG. 3 is an isometric view of an engine block having located thereon a head and showing a multitude of electromagnets located in said head.

FIG. 4 is an isometric view of two limiting pistons showing one at top dead center and one at bottom dead center creating a reciprocating motion of a magnetically powered reciprocating engine consisting of an up and down or back and forth motion as contrasted with the rotary motion of the crankshaft.

FIG. 5 is an isometric schematic of an electrical power system for a magnetically powered reciprocating engine showing its motor components consisting of an ignition switch, distributor, battery and alternator.

FIG. 6 details a throttle and linkage apparatus of a magnetically powered engine composing a variable-resistance accelerometer.

FIG. 7 isometrically illustrates a driveshaft apparatus consisting of a mechanical power system of an automobile.

### DESCRIPTION OF PREFERRED EMBODIMENTS

The typical gasoline powered engine receives its power from the chemical energy in a gasoline and air mixture. The gasoline is vaporized in a carburetor. Within the carburetor, air is sucked into an air filter and then around a tube filled with gas pumped from the gas tank. The air rushes past the tube, and it carries along some gas vapor, and the mixture goes to one of the cylinders. Cylinders are large tubes sealed at one end and blocked at the other by a movable plug called a piston. As the piston moves down, it sucks in the gas/air mixture from the carburetor through a pipe called the intake manifold. When the piston reaches the bottom of its stroke, the inlet valve closes, and the piston moves back up the cylinder, compressing the gas/air mixture to rest in one-sixth of its original volume. This is generally known as the compression ratio.

Now referring to FIG. 1 of the present invention, there is shown a magnetically powered engine 10 having a cylinder 14a, a piston 16a and piston ring 18a. Magnetically powered engine 10 is adaptable to and modifiable to any gasoline powered automobile, truck, marine and other small engine as referenced above. Components of the gasoline powered engine have been removed, including the carburetor, spark plugs, valves, intake manifold, gasoline lines and gasoline tank. Piston ring 18a is provided and fits into grooves on piston 16a. Piston ring 18a is utilized to seal a compression pressure in the cylinder 14a, henceforth scraping excess oil off the inside wall of cylinder 14a.

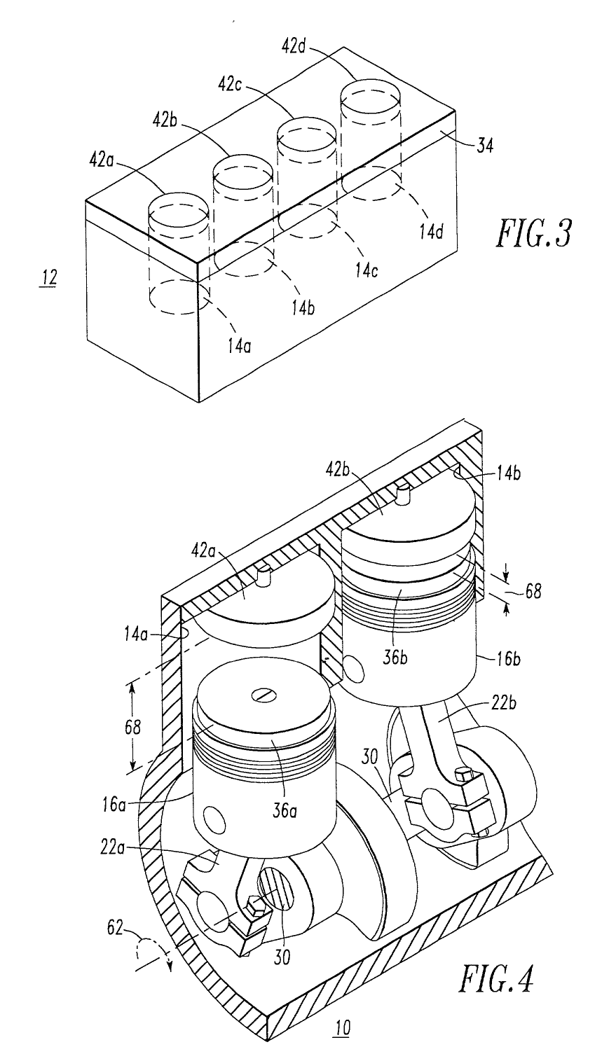

There is shown a four cylinder engine block 12 in FIG. 3 including head 34 and having cylinder 14a, cylinder 14b, cylinder 14c and cylinder 14d aligned in a straight series within engine block 12. Engine block 12 is a typical straight block. However, the present invention, a magnetically powered engine 10 is applicable to any type of engine block, including but not limited to, those having one, two, three, four, six, eight or ten cylinders. Engine blocks that have their cylinders in a row or in a line are known as straight blocks. Another type of engine block is known as the V type and has at least two rows or banks set at an angle to each other. Typical V type blocks are V-4, V-6, and V-8. There are also flat blocks where the cylinders are aligned in two or more rows or banks opposing each other in a flat or pancake-like block.

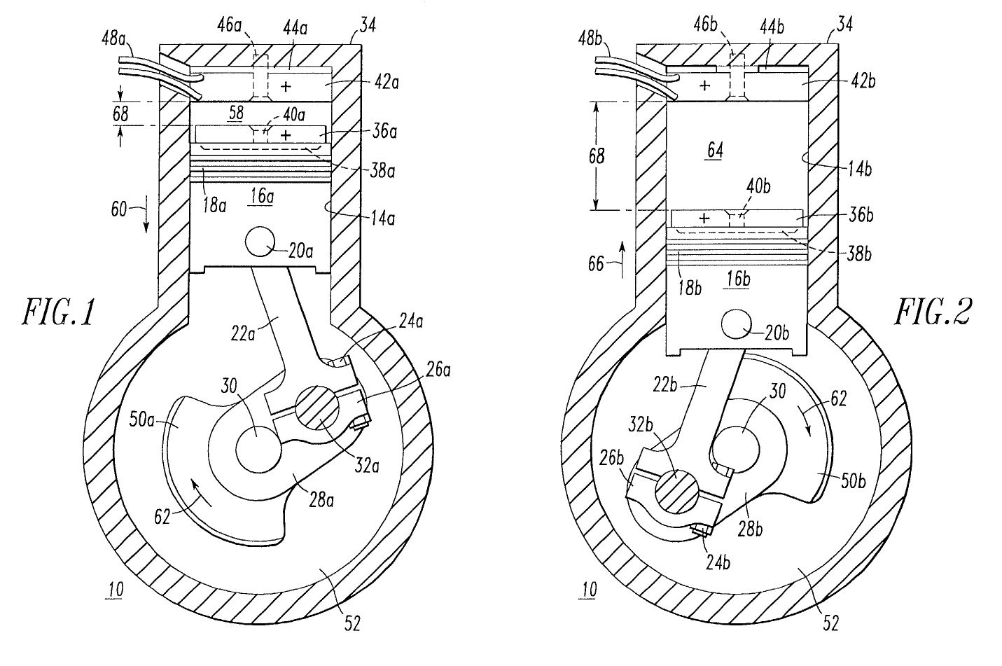

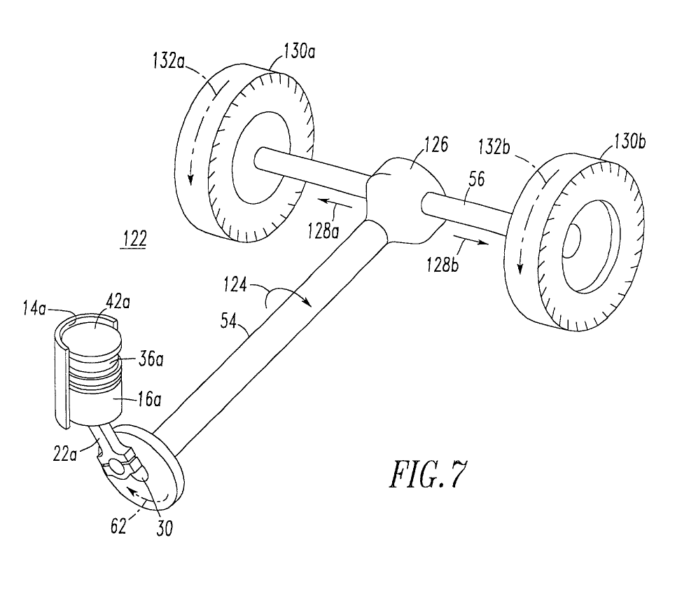

It is shown in FIG. 1 that a permanent magnet 36a is secured to the top of piston 16a. Referring again to FIG. 3 and FIG. 1, there is shown an electromagnet 42a, electromagnet 42b, electromagnet 42c and electromagnet 42d secured to head 34 of engine block 12. Now, referring again to FIG. 1, permanent magnet 36a and electromagnet 42a, being of the same electrical charge, create repulsive electromagnetic field 58 resultant in a downward piston motion 60. Piston 16a is connected to connecting rod 22a and transmits a downward force through connecting rod 22a to crankshaft 30 converting downward piston motion 60 to clockwise crankshaft motion 62. Thus, downward piston motion 60 is transmitted to clockwise crankshaft motion 62 and through a transmission to driveshaft 54 as shown in FIG. 7. Connecting rod 22a rotates about piston 16a around piston pin 20a. Connecting rod 22a is also connected to crankshaft 30 through crank pin 32a. First insulator 38a and first insulator 38b as shown in FIGS. 1 and 2 insulate electromagnet 42a and electromagnet 42b from piston 16a and piston 16b, respectively, preventing transfer of any electromagnetism or current to piston 16a and piston 16b. Likewise, second insulator 44a and second insulator 44b insulate electromagnet 42a and electromagnet 42b from electromagnetism or current being transferred to head 34. Piston stroke 68 represents the distance up or down that piston 16a and piston 16b move.

A preferred embodiment of permanent magnet 36a and permanent magnet 36b is an alnico which derives its magnetic properties from its main constituents, being aluminum, nickel and cobalt. These permanent magnets have a wide range of temperature stability and include characteristics of high induction, as well as relatively high energy. Alnico magnets are manufactured by sintering or casting. Electromagnet 42a and electromagnet 42b, in their preferred embodiments, provide an efficient and economical solution for creation of a maximum holding force on a flat, smooth, dry, unpainted surface where the entire space of the magnet comes in direct contact with a similar surface as shown in permanent magnet 36a and permanent magnet 36b. In their preferred embodiments, permanent magnet 36a and permanent 36b and electromagnet 42a and electromagnet 42b are cylindrical in shape conforming to most gasoline powered automobile, truck, marine and other small engine blocks and cylinders.

FIG. 2 is illustrative of magnetically powered engine 10 showing permanent magnet 36b secured to piston 16b within cylinder 14b and electromagnet 42b secured to the head 34. When electromagnet 42a is in the charged state, electromagnet 42b is in a no charge state permitting free movement of piston 16b in the direction of upward piston motion 66 being opposite to downward piston motion 60. When an opposite charge is created between electromagnet 42b and permanent magnet 36b, a repulsive electromagnetic field 64 is created causing piston 16b to move away from electromagnet 42b in a downward piston motion opposite of upward piston motion 66.

As seen in FIG. 2, piston 16b is connected to connecting rod 22b by piston pin 20b and crank pin 32b allowing reciprocating motion to be transferred from piston 16b to or converted from the upward and downward reciprocating motion of piston 16b to rotational motion 62. As seen in FIGS. 1 and 2, rod bolt 24a and rod bolt 24b secure connecting rod 22a and connecting rod 22b around crank pin 32a and crank pin 32b, respectively, which are connected as shown to crankshaft 30.

FIG. 1 illustrates piston 16a moving downward from a top dead center position. FIG. 2 illustrates piston 16b moving upward from its bottom dead center. Thus, assuming that magnetically powered engine 10 is a two cylinder engine, as shown in FIG. 4, the reciprocating motion illustrated as downward piston motion 60 and upward piston motion 66 combine to move in reciprocating fashion up and down in cylinders 14a and 14b, respectively, causing clockwise crankshaft motion 62. FIG. 4 illustrates a two cylinder reciprocating engine indicating, again, the top dead center and bottom dead center positions of piston 16a and piston 16b and piston stroke 68 representing the distance piston 16a and piston 16b move.

Crankshaft 30, in its preferred embodiment, is generally a one-piece casting or forging of heat-treated alloy steel. Counter weight 50a and counter weight 50b are placed opposite crank pin 32a and crank pin 32b to balance crankshaft 30. Connecting rod 22a and connecting rod 22b each have a crank pin 32a and crank pin 32b for pivotal rotation around crankshaft 30 in respective fashion and are collectively within crankcase 52. Crank 28a and crank 28b connect crankshaft 30 and crank pin 32a and crank pin 32b together to operate as aforesaid. Rod cap 26a and rod cap 26b act cooperatively with rod bolt 24a and rod bolt 24b to connect crankshaft 30 by and through connecting rod 22a and connecting rod 22b, all respectively. An oil or other suitable lubricant is contained within crankcase 52 for lubrication of all the aforesaid components contained within crankcase 52 and within cylinder 14a, cylinder 14b, cylinder 14c and cylinder 14d.

Permanent magnet 36a and permanent magnet 36b are secured to piston 16a and piston 16b, respectively, by a first plow bolt 40a and a second plow bolt 40b or any other similar fastening means. Likewise, electromagnet 42a and electromagnet 42b are secured to head 34 by third plow bolt 46a and fourth plow bolt 46b, respectively, or any other similar fastening means. Electromagnet 42a receives an electrical current through electrical leads 48a when no current is transferred to electromagnet 42b. Likewise, electromagnet 42b receives an electrical current through electrical leads 48b when no current is transferred to electromagnet 42a. This description of magnetically powered engine 10 is with reference to same constituting two cylinders reciprocating as shown in FIGS. 1, 2 and 4.

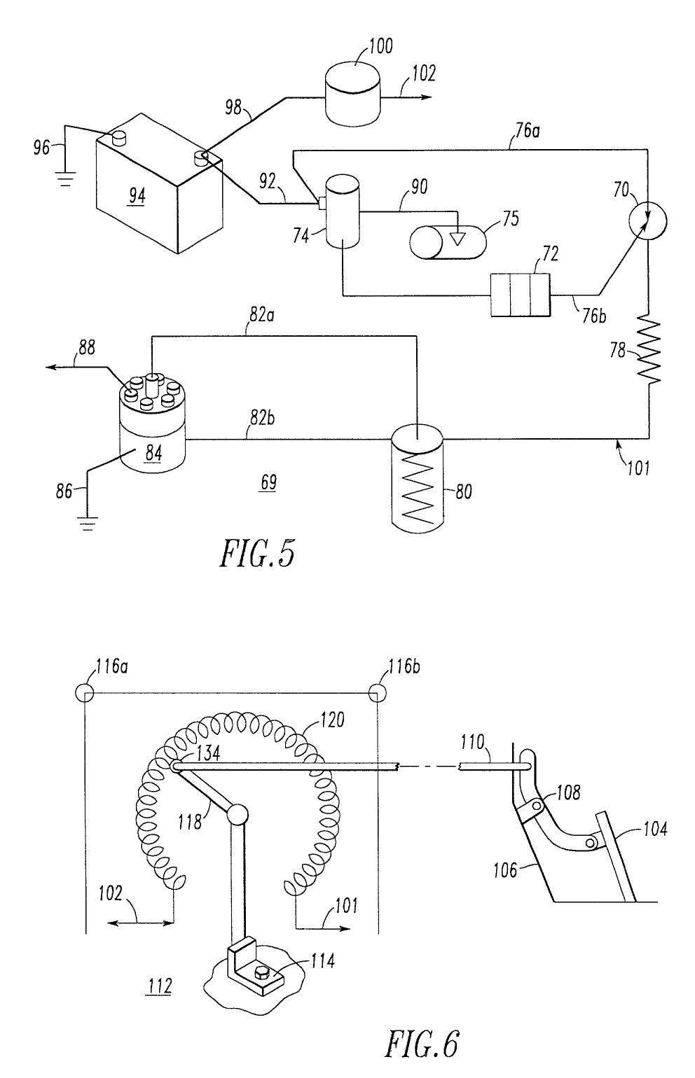

An electrical power system 69 is shown in FIG. 5. The electrical power system 69 produces electrical energy in alternator 100. Electrical energy is stored in chemical form in battery 94. In combination, alternator 100 and battery 94 deliver electrical energy on demand to electromagnet 14a and electromagnet 14b located in magnetically powered engine 10 as shown in FIGS. 1, 2 and 4. When ignition switch 70 is turned on, or in a closed position, electromagnet 42a, electromagnet 42b, and likewise, electromagnet 42c and electromagnet 42d receive an electrical charge from distributor 84 as shown in a four cylinder block in FIG. 3. Distributor 84 acts as an automatic switch sending the necessary electrical current to electromagnet 42a, electromagnet 42c and then alternatively to electromagnet 42b and electromagnet 42d through lead 88. Distributor 84 is grounded by cable 86. Likewise, battery 94 is grounded by cable 96.

Ignition switch 70 connects to ignition coil 80 through resistance wire 78. Ignition coil 80 acts as a step up transformer that raises voltage in battery 94. Contact points or breaker points in distributor 84 act as fast-acting switches sending current through electromagnet lead 88 to electromagnet 42a, electromagnet 42b, electromagnet 42c and electromagnet 42d as aforestated. The electrical power system 69 further consists of ignition wire 76a and ignition wire 76b. Ignition wire 76a leads to starter relay 74 which acts as an electrical device to open and close the electrical circuit in response to voltage signals. Starter lead 90 is connected to a starter motor 75. Ignition wire 76b connects to connector 72 which also leads to starter relay 74. Resistance wire 78 is placed between ignition switch 70 and coil 80 to prevent the primary circuit from arcing and burning. Coil wire 82a and coil wire 82b lead from coil 80 and connect to distributor 84. Likewise, lead 90 connects to starter motor 75 such that lead 90 is connected to both starter relay 74 and starter motor 75 which all complete the electrical circuits. Alternator lead 98 connects alternator 100 with battery 94. Starter motor 75 in its preferred embodiment, consists of a small, powerful, electric motor that converts electrical energy from the battery 94 into mechanical energy to spin the crankshaft 30 and start magnetically powered reciprocating engine 10. Starter relay 74 functions to control the electrical power system 69 as when a driver turns ignition switch 70 to an on position, heavy contacts close in starter relay 74. This allows high current to flow from battery 94 to starter motor 75.

Now, referring to FIG. 6, there is shown an accelerator pedal 104 mounted by pedal bracket assembly 108 to dash panel 106. Accelerator pedal 104 is connected by throttle cable 110 to an electro accelerator 112. Electro accelerator 112 is secured to magnetically powered engine 10 by electro accelerator bracket assembly 114. Electro accelerator 112 is a variable-resistance device with three terminals as set forth in FIG. 6 of the drawings. Terminal 116a and terminal 116b comprise two of the terminals at the end of a resistor element 120 and movable connection 118 allows for adjustment of the resistance between movable connection 118 and either terminal 116a or terminal 116b. Movable connection 118 consists of a sliding contact 134 which moves along resistor element 120. Thus, by application of electro accelerator 112, electrical current is adjusted and controlled allowing the revolutions per minute of crankshaft 30 to be increased or decreased. Lead 102 provides current to electro accelerator 104 and lead 101 transfers current to coil 80.

FIG. 7 illustrates a drive line assembly 122 consisting of a driveshaft 54 that transmits torque shown through clockwise driveshaft motion 124 to differential 126. Differential 126 is a device or gear assembly located on rear axle 56 and functions to transmit torque to rear wheel 130a and rear wheel 130b as is respectively indicated by directional arrows 128a and directional arrow 128b. Illustrated in FIG. 7 is electromagnet 42a and permanent magnet 36a within cylinder 14a. Thus, as piston 16a reciprocates upward and downward, power is transmitted through connecting rod 22a to crankshaft 30 through a transmission (which is not shown) to driveshaft 54 creating clockwise crankshaft motion 62 transmitted to clockwise driveshaft motion 124. Rear wheel 130a and rear wheel 130b then rotate as indicated by rotary wheel arrow 132a and rotary wheel arrow 132b to cause a vehicle to move with forward motion and by means of a transmission in reverse to backward motion.

In accordance with the provisions of the patent statutes, I have explained the principal and operation of my invention, and I have illustrated and described what I consider to represent the best embodiment thereof.

I claim:

1. A magnetically powered engine adaptable to and modifiable to any gasoline-powered automobile, truck, marine and other small engines comprising, in combination:
an engine block having at least one cylinder, at least one piston, a crankcase, at least one connecting rod secured to a lower portion of said piston and pivotally to a crankshaft enclosed in said crankcase;
an electrical power source providing electrical current to an electromagnet fastened within a head of said cylinder;
a permanent magnet secured to an upper surface of said piston for creation of a repulsive magnetic field between said electromagnet and said permanent magnet, causing said permanent magnet to drive said piston away from said electromagnet in said head driving said piston in an upward motion and then in a downward motion within said cylinder, and thereby, transferring said upward motion and said downward motion to said crankshaft by means of said connecting rod.

2. A magnetically powered engine adaptable to and modifiable to any gasoline-powered automobile, truck, marine and other small engines according to claim 1, wherein said electrical power source consists of a battery, whereby said battery supplies said electrical current to said electromagnet.

3. A magnetically powered engine adaptable to and modifiable to any gasoline-powered automobile, truck, marine and other small engines according to claim 2, wherein said electrical power source further consists of an ignition switch connecting to a coil, connecting to said battery, whereby turning said ignition switch to a closed position causes said electrical current to flow to said electromagnet, causing an electrical charge to be transmitted to said electromagnet.

4. A magnetically powered engine adaptable to and modifiable to any gasoline powered automobile, truck, marine and other small engines according to claim 3, whereby an accelerator pedal connects by a throttle cable to a variable-resistance accelerometer for increasing said electrical current and concurrently for increasing power to said electromagnet.

5. A magnetically powered engine adaptable to and modifiable to any gasoline-powered automobile, truck, marine and other small engines according to claim 4, whereby said variable-resistance accelerometer comprises three terminals located at a first end of a resistor, a second end of said resistor and a movable connection which allows adjustment of a resistance between said movable connection and said first end and said second end of a static connector for adjustment of an electrical potential difference to an electrical circuit.

6. A magnetically powered engine adaptable to and modifiable to any gasoline-powered automobile, truck, marine and other small engines according to claim 5, whereby said movable connection consists of a sliding contact moving along said resistor for controlling said electric potential applied to an alternator consisting of a component of said electrical power source.

7. A magnetically powered engine adaptable to and modifiable to any gasoline-powered automobile, truck, marine and other small engines according to claim 5, whereby a distributor is included as a component of said electrical power source, said distributor consisting of a device comprised of a rotary switch that directs high-voltage surges to increase said electrical current to at least one of said electromagnets.

8. A magnetically powered engine adaptable to and modifiable to any gasoline-powered automobile, truck, marine and other small engines according to claim 7, whereby said distributor acts as a timing device to send said timed high-voltage surges to a plethora of said electromagnets.

9. A magnetically powered engine adaptable to and modifiable to any gasoline-powered automobile, truck, marine and other small engines according to claim 7, whereby at least said one permanent magnet is opposed to at least one of said electromagnets, whereby said distributor transmits an opposite charge to said electromagnet, said opposite charge being opposite to a fixed charge of said permanent magnet.

10. A magnetically powered engine adaptable to and modifiable to any gasoline powered automobile, truck, marine and other small engines according to claim 9, whereby a plurality of said permanent magnets are opposed to an equal plurality of electromagnets operating to cause an opposing electric magnetic force in a second cylinder, thus, alternating said magnetic force from said second cylinder to said second cylinder, and in each successive of said plurality of cylinders, each of said cylinders contained in said engine block and acting cooperatively in an upward and downward motion to cause rotational motion to said crankshaft.

11. A magnetically powered engine adaptable to and modifiable to any gasoline-powered automobile, truck, marine and other small engines according to claim 10, whereby said crankshaft connects to a transmission for transmitting mechanical power from said magnetically powered engine through a driveshaft to an axle connecting thereto at least one wheel causing said automobile, truck, and other road vehicle to travel in a fixed direction.

12. A magnetically powered engine adaptable to and modifiable to any gasoline-powered automobile, truck, marine and other small engines comprising, in combination:
an engine block having at least one cylinder, at least one piston, a crankcase, at least one connecting rod secured to a lower portion of said piston and pivotally to a crankshaft enclosed in said crankcase, whereby in an automobile, truck and other road vehicles, said crankshaft connects to a transmission for transmitting mechanical power from said magnetically powered engine through a driveshaft to an axle connecting thereto at least one wheel causing said automobile, truck and other road vehicles to travel in a fixed direction;
an electrical power source providing electrical current to an electromagnet fastened within a head of said cylinder, whereby said electrical power source consists of a battery, whereby said battery supplies said electrical current to said electromagnet;
a permanent magnet secured to an upper surface of said piston for creation of a magnetic field between said electromagnet and said permanent magnet, causing an opposing magnetic force between said electromagnet and said permanent magnet driving said piston away from said electromagnet in said head and reciprocating to allow said piston to move away from said electromagnet, thus, reciprocating from opposing polarities to free motion driving said piston upward and then downward within said cylinder, and thereby, transferring said upward motion and said downward motion to said crankshaft by means of said connecting rod, whereby said permanent magnet is opposed to said electromagnet, and whereby a distributor transmits a charge to said electromagnet, said charge being opposite to a fixed charge of said permanent magnet.

13. A magnetically powered engine adaptable to and modifiable to any gasoline-powered automobile, truck, marine and other small engines according to claim 12, wherein said electrical power source further consists of an ignition switch connecting to a coil, connecting to said battery, whereby turning said ignition switch to a closed position causes said electrical current to flow to said electromagnet, causing an electrical charge to be transmitted to said electromagnet.

14. A magnetically powered engine adaptable to and modifiable to any gasoline-powered automobile, truck, marine and other small engines comprising, in combination:
an engine block having a plurality of cylinders, an equal plurality of pistons, a crankcase, one connecting rod secured to each of said plurality of pistons at a lower portion of said pistons and pivotally to a crankshaft enclosed in said crankcase;
an electrical power source providing electrical current to a plurality of electromagnets fastened within a head of said plurality of said cylinders, whereby the number of said plurality of electromagnets is equal to the number of said plurality of cylinders;
a plurality of permanent magnets secured to an upper surface of said plurality of said pistons being an equal number to said plurality of pistons for creation of a magnetic field between each of said electromagnets and each of said permanent magnets causing an opposing magnetic force between each of said electromagnets and each of said permanent magnets driving each of said pistons away from each of said opposing electromagnets in said head and reciprocating to cause a repulsive magnetic force between each of said electromagnets and said permanent magnets, driving one of said plurality of pistons in a first direction away from one of said plurality of electromagnets, and thus, reciprocating to an adjacent cylinder to drive a second of said plurality of pistons away from a second of said plurality of electromagnets, thus, reciprocating from opposing polarities to free motion in sequence from one to another of said adjacent cylinders, and thereby, transferring said upward motion and said downward motion to said crankshaft by means of said connecting rod causing rotational crankshaft motion.

15. A magnetically powered engine adaptable to and modifiable to any gasoline-powered automobile, truck, marine and other small engines according to claim 14, wherein said electrical power source consists of a battery, whereby said battery supplies electrical current to each of said electromagnets, further including in said electrical power source an ignition switch connecting to a coil, connecting to said battery, whereby turning said ignition switch to a closed position causes said electrical current to flow to each of said electromagnets, causing an electrical charge to be transmitted to each of said electromagnets, said electrical charge alternating from an opposing charge to no charge in each of said plurality of adjacent electromagnets.
